(19) United States
(12) Patent Application Publication
(10) Pub. No.: US 2011/0020576 A1
(43) Pub. Date: Jan. 27, 2011

(54) Polystyrene Preform Design for Blow Molding of Articles

(75) Inventors: Luyi Sun, Pearland, TX (US); Mark Leland, Houston, TX (US); Juan Aguirre, League City, TX (US); Ted Harris, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/508,600

(22) Filed: Jul. 24, 2009

(51) Int. Cl. B29C 49/06; B32B 1/00

(52) U.S. Cl. 428/36.92; 264/537

(57) ABSTRACT

Preforms for use in injection blow molding processes and such processes are described herein. The preforms can have both a body and a neck wherein the external body diameter of the preform is at most 95% of the external neck diameter. The body comprises internal and external diameters that together form a sidewall, the thickness of which can be greater than 2.0 mm. Also disclosed is a mold for the injection molding of the preform described above.

### FIELD

The present invention generally relates to the process of blow molding of plastics. In particular, embodiments of the invention relate to preforms for injection blow molding and injection stretch blow molding of styrene based polymers.

### BACKGROUND

Polymeric materials are often used as packaging materials because they can create a good oxygen/moisture barrier and their appearance and shape can be easily controlled. Plastic materials are also used in place of glass for bottling because they are lighter, are more resistant to breakage when dropped, and can be less expensive. Several common polymeric materials used for packaging are polyethylene (PE), polyethylene terephthalate (PET), polypropylene (PP), polycarbonate (PC), and polystyrene (PS).

Polystyrene is one of the largest volume thermoplastic resins in commercial production today. It is a hydrocarbon chain containing a phenyl group on every other carbon atom. Polystyrene is a durable and inexpensive polymer which is frequently encountered in daily life. A few common examples of polystyrene are plastic toys, computer housings, foam packaging, foam cups, etc.

Injection blow molding (IBM) is a technique that can be used to produce plastic containers. A molten polymer is injected into a preform mold, creating a preform. The preform is then heated and blown into its finished shape using compressed gas to fill a given mold and produce a hollow container.

Injection stretch blow molding (ISBM) is another technique to produce a variety of plastic containers. Granules of the desired material are melted and injected into a mold to create a preform. The preform is heated, and then stretched, and blown with high-pressure gas, such as air, to fill a given mold and produce a hollow container.

For each material, owing to their different physical properties, including coefficient of heat transfer, heat capacity, shrinkage, heat deformation temperature, etc., it is imperative to design specific preforms to achieve acceptable overall processability and bottle properties.

Preforms for polyethylene terephthalate (PET), polypropylene (PP), and polycarbonate (PC) have been well developed and have their own design features. It is desirable to have a polystyrene (PS) preform design with optimized performance which could lead to good processability, high production rate, low energy consumption, and good bottle properties.

### SUMMARY

An embodiment of the present invention is a preform for use in blow molding processes of polystyrene based polymer. The preform has a neck with an internal neck diameter and an external neck diameter and having a first neck end (E₁) and a second neck end (E₂). The neck provides the open end of the preform and blown article and contains the sealing portion of the preform, such as a threaded portion or an alternate cap attachment contour. The preform has a body with an internal body diameter and an external body diameter that together form a sidewall. The body has a first body end (E₂, which is also the second neck end) and a second body end (E₃) that is closed, which together form a first body length (h₁). The body has a first external body diameter (d₁) at the first body end (E₂) and a second external body diameter (d₂), the second external body diameter being less than the first external body diameter. The body has a transition zone defined by the length wherein the external body diameter decreases from the first external body diameter to the second external body diameter, the location where the body external diameter equals the second external body diameter defining a transition point (T). The body has a second body length (h₂) from the transition point (T) to the second body end (E₃). The second external body diameter is at most 95% of the first external body diameter and the second body length is at most 95% of the first body length. The length of the transition zone is at least 50% of (d₁-d₂).

The second external body diameter can range from 50% to 95% of the first external body diameter. The second body length can range from 60% to 95% of the first body length. For a 31 g preform to be used for a 500 mL blown bottle, its first external body diameter can range from 25.0 mm to 40.0 mm; its second external body diameter can range from 12.5 mm to 38.0 mm; its sidewall thickness at the location where the external body diameter is d₂ can be at least greater than 2.0 mm or at least greater than 3.00 mm.

The preform material can be a polystyrene or a polymeric mixture comprising a majority of polystyrene. The preform can include a gas-barrier coating material. The preform can have a shrinkage of less than 38%, optionally less than 30% when reheated during a blow molding process. The preform can have a warpage of less than 8.5%, optionally less than 4.0% when reheated during a blow molding process.

An embodiment of the invention can be an article formed by the blow molding of the preform. An embodiment of the invention can be a preform mold used for the molding of the preform.

An embodiment of the present invention is a method of forming a blow molded article, the method including providing a polystyrene based polymer and forming a preform from the polystyrene based polymer. The preform includes a neck having an internal neck diameter and an external neck diameter and having a first neck end and a second neck end. The preform includes a body having an internal body diameter and an external body diameter that together form a sidewall. The body has a first body end connected to the second neck end and a second body end that is closed, which together form a first body length. The body has a first external body diameter at the first body end and a second external body diameter at a distance of at least half the length of the body from the neck, the second external body diameter being less than the first external body diameter. The body has a transition zone defined by the length wherein the external body diameter decreases from the first external body diameter to the second external body diameter, the location where the body external diameter equals the second external body diameter defining a transition point. The body has a second body length from the transition point to the second body end. The second external body diameter is at most 95% of the first external body diameter and the second body length is at most 95% of the first body length. The method further includes heating the preform and injection blow molding the preform into an article.

The method can further include injection stretch blow molding the preform into an article. The second external body diameter of the preform can range from 50% to 95% of the first external body diameter of the preform. The second body length of the preform can range from 60% to 95% of the first body length of the preform.

The thickness of the preform sidewall can be greater than 3.00 mm for a 500 mL, 31 g preform. The method can further include that the heating of the preform results in shrinkage of less than 38%, optionally less than 30%. The method can further include that the heating of the preform results in a warpage of less than 8.5%, optionally less than 4.0%.

An embodiment of the invention can include an article formed by the method described herein.

### BRIEF DESCRIPTION OF DRAWINGS

FIG. 1 shows a schematic for three preform designs discussed herein.

FIG. 2 shows the bottoms of two articles formed with the design B preform showing non-uniform thickness and whitening (left) or blow-out (right).

FIG. 3 shows a cross section of a preform illustrating shrinkage and warpage resulting from heating.

FIG. 4 shows the 680 HIPS preform designs A1, A2, and B respectively before and after heating.

FIG. 5 shows the CX5229 preform designs A1, A2 and B respectively before and after heating.

FIG. 6 shows the top load strength of the 680 HIPS and CX5229 bottles.

FIG. 7 shows the bumper compression strength of the 680 HIPS and CX5229 bottles.

### DETAILED DESCRIPTION

Injection blow molding (IBM) and injection stretch blow molding (ISBM) are well-developed techniques to produce plastic containers that include the formation of a perform that is subsequently heated and blow molded to produce a hollow container. Preforms are generally condensed shapes, which may include relatively thick-walled tube shaped articles having a threaded neck to facilitate appropriate closure. The preforms can be blown into a desired article shape by heating, stretching, and blowing the preform with a compressed gas. The compressed gas expands the preform into the shape of the mold.

The shape and thickness of the preform determines not only the processability and production rate for the blow molding process, but also the properties of the article produced, including mechanical, physical, and optical properties. When a polymer is sensitive to a temperature change, a slight non-uniform heating may have a significant effect on the polymer distribution. This can lead to the polymer being unevenly distributed in the mold, resulting in an article weakness that may lead to failure. As used here, “failure” is measured by visual inspection and usually results from concentrating (either stretching too much or too little) in any region of an article. The article defects may further be measured via mechanical testing. Another consideration on preform design is energy consumption. It is desirable to design preforms that can be easily reheated quickly to the required temperature window throughout the preform with minimized energy consumption.

The ISBM process can be either a single or double stage process. The single stage process injects the molten polymer into the preform mold creating the preform, stretches the preform, and blows the preform into the finished shape all in the same process. In a double stage process, performs are injection molded at the first stage. After the preforms are cooled down, they are reheated and subsequently stretched/blow molded into bottles at the second stage.

For each polymer material, owing to their different physical properties, it is desirable to design specific preforms to achieve best overall processability and bottle properties. The physical properties that can influence the processability of the polymer material include the coefficient of heat transfer, heat capacity, shrinkage, heat deformation temperature, and melt strength.

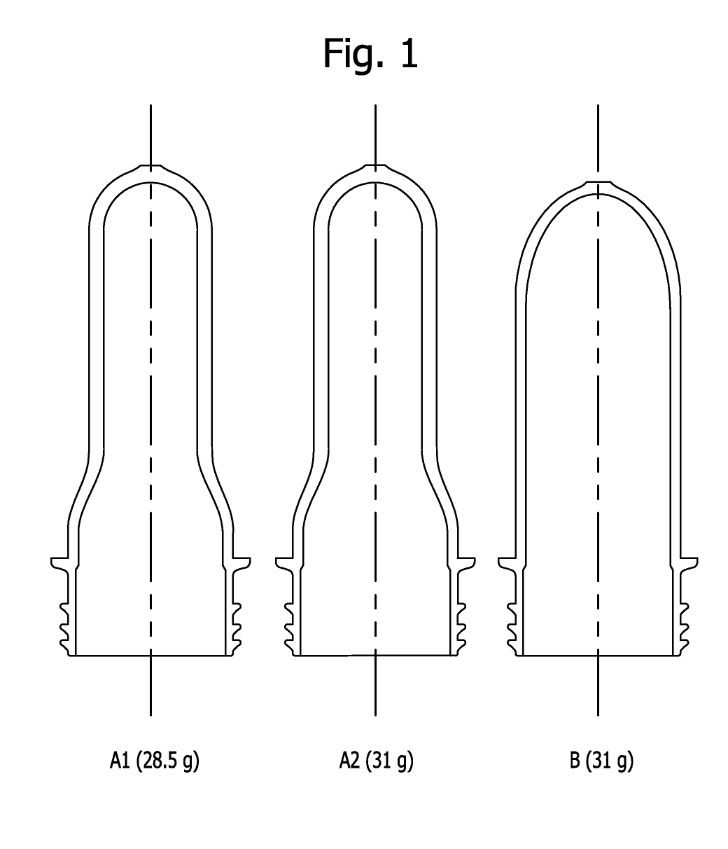

Polystyrene is a material under development for blow molding applications. An initial evaluation of polystyrene for ISBM applications used a preform design referred to as design B as shown in FIG. 1. Design B is a typical preform design to start with, because it has a simple shape (thus easy for injection molding) and a thin wall, which allows the preforms to be quickly reheated to the desired temperature window and facilitate heat transfer. Such a design feature not only helps save energy, but can also facilitate the following blowing process (e.g. lower blow pressure is possible). It works well for several plastics, including PP and PET.

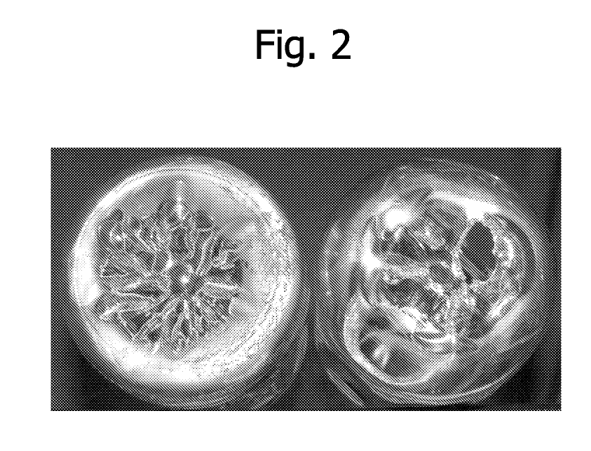

However, when PS was evaluated with such a preform design (design B), a high reject rate occurred during production and the molded bottles exhibited inconsistent properties. Both crystal and high impact polystyrene (HIPS) grades exhibited certain levels of shrinkage and warpage, which prevents the successful blow molding of polystyrene, especially for the crystal grade polystyrene. Owing to its straight sidewall shape and relatively thin wall as shown in FIG. 1, the preforms shrink significantly during reheating. Any uneven shrinkage during reheating can result in warpage along the preform axial (off-center). Such off-centered preforms can give rise to a non-uniform bottle bottom and poor mechanical properties. In addition, the bottle bottom can show signs of whitening, an undesirable characteristic for the finished part as shown in FIG. 2. Overall, HIPS grades exhibited relatively high shrinkage but low warpage during the trial, thus it was possible to blow HIPS into bottles. The crystal polystyrene grades exhibited significant uneven shrinkage and warpage during the reheating process, leading to an off-centered bottle bottom and non-uniform wall thickness. The evaluation has shown that design B is not suitable for PS ISBM. Thus, it is important to design a preform that can minimize uneven shrinkage and warpage so as to avoid the processing issues they present.

In order to minimize the uneven shrinkage and resulting warpage on the preforms during the reheating process, new preforms were designed (A1 and A2) and evaluated. Designs A1 and A2 have the same external dimension and shape, but A2 has a slightly thicker wall. Both A1 and A2 have a greater wall thickness than design B (FIG. 1). The results have shown that preforms with greater wall thickness and a bell shaped section near the neck are desirable designs for polystyrene applications in terms of smooth processing owing to minimized uneven shrinkage and warpage. The dimensions of the preform designs A1, A2, and B that were tested are shown in Table 1.

TABLE 1

| | | | | | | Wall |
|---|---|---|---|---|---|---|
| | H₁ | h₁ | h₂ | d₁ | d₂ | thickness |
| Preform | mm | mm | mm | mm | mm | mm |
| A1 | 104.21 | 83.21 | 62.73 | 34.8 | 26.11 | 3.05 |
| (28.5 g) | | | | | | |
| A2 | 104.21 | 83.21 | 62.73 | 34.8 | 26.11 | 3.58 |
| (31.0 g) | | | | | | |
| B | 100.61 | 79.61 | 79.61 | 34.8 | 34.8 | 2.8 |
| (31.0 g) | | | | | | |

Embodiments of the present invention have a thickness of at least 2.00 mm, optionally at least 2.50 mm, optionally at least 3.00 mm, optionally at least 3.25 mm, optionally at least 3.5 mm. Embodiments of the present invention have a first external body diameter from 25.0 mm to 40.0 mm, optionally from 30.0 mm to 38.0 mm, optionally from 33.0 mm to 37.0 mm. Embodiments of the present invention have a second external body diameter from 12.5 mm to 38.0 mm, optionally from 20.0 mm to 31.0 mm, optionally from 24.0 mm to 28.0 mm.

Embodiments of the present invention have a neck length of from 14 mm to 26 mm, optionally from 15 mm to 24 mm, optionally from 16 mm to 22 mm.

To evaluate the preform design on the reheating blow molding processing, two polystyrene grades (one crystal grade, CX5229; and one impact grade, 680 HIPS) available from TOTAL Petrochemicals, USA, Inc. were chosen for evaluation on three preform designs, A1 (28.5 g), A2 (31 g), and B (31 g). The two resins were molded into preforms on a Netstal Injection Molder. The preforms were conditioned at room temperature for at least 24 hours before they were stretch-blow-molded into bottles on an ADS G62 linear injection stretch blow molder.

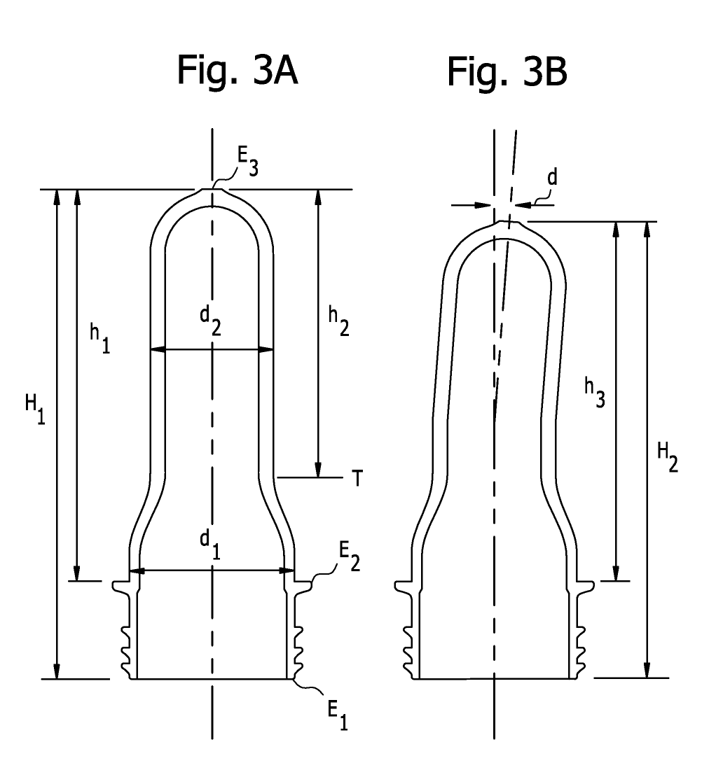

Referring to FIG. 3, there is illustrated a cross section view of an embodiment of a preform before heating (FIG. 3a) and after heating (FIG. 3b). The first external body diameter (d₁), second external body diameter (d₂), preform length (H₁), preform length after heating (H₂), first body length (h₁), second body length (h₂), body length after heating (h₃), amount of deviation (d), and transition point (T) are shown in FIG. 3. Shrinkage is defined as (h₁-h₃)/h₁ and warpage is defined as d/h₃. For determining a suitable size and angle of slope of the bell shaped neck of the preform the following parameters are desired. The ratio of the second external body diameter (d₂) to the first external body diameter (d₁) should range between 0.50 and 0.95, optionally from 0.60 to 0.90, optionally from 0.70 to 0.80. The ratio of the second body length (h₂) to the first body length (h₁) should range from 0.60 to 0.95, optionally from 0.65 to 0.85, optionally from 0.65to 0.80. End locations of the neck and body sections are shown as E₁, E₂ and E₃, with E₁ indicating the open end of the preform, E₂ indicating the location where the neck section connects with the body section and E₃ indicating the closed end of the preform. A support ring is located at E₂ that can assist with the preform handling and blow molding process.

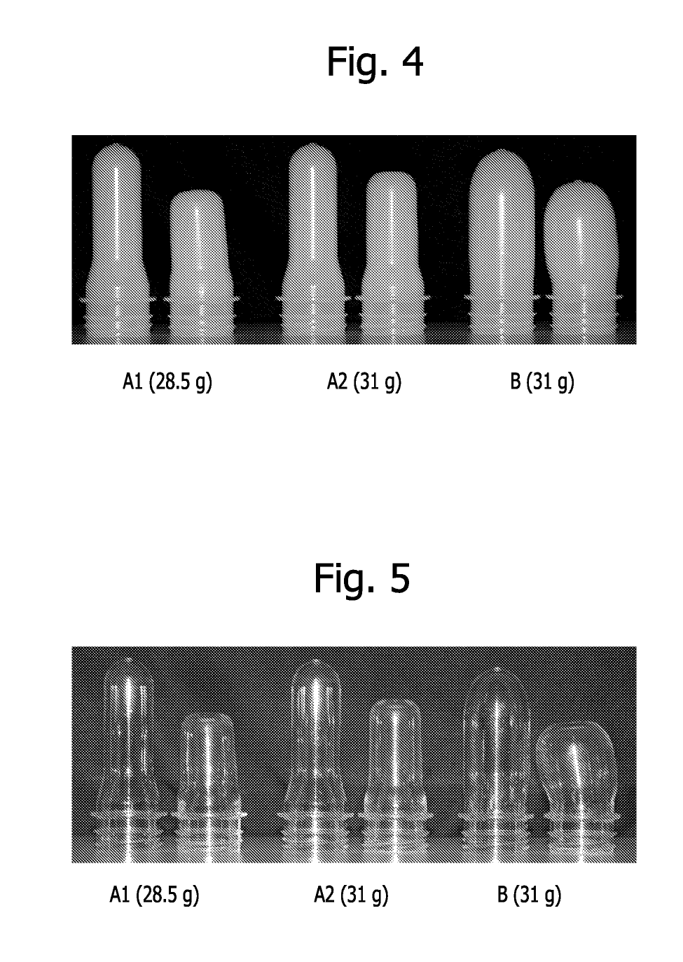

The evaluation results show that designs A1 and A2 appear to be suitable for polystyrene blow molding processes. After reheating, the preforms shrink less, shrink more uniformly and exhibit lower warpage than the comparative preform B (see Table 2, FIG. 4 and FIG. 5). Bottles were successfully blow molded at a reject rate lower than 2% using either design A1 or A2. The bottle bottoms did not exhibit signs of whitening. FIG. 4 shows the 680 HIPS preform designs A1 (28.5 g), A2 (31 g), and B (31 g) respectively before and after heating. FIG. 5 shows the CX5229 preform designs A1 (28.5 g), A2 (31 g), and B (31 g) respectively before and after heating.

TABLE 2
Shrinkage and warpage data of PS preforms.

| | A1 (28.5 g) | A2 (31 g) | B (31 g) |
|---|---|---|---|
| Shrinkage | | | |
| CX5229 | 33% | 25% | 38% |
| 680 HIPS | 28% | 16% | 23% |
| Warpage | | | |
| CX5229 | 3.7 | 1.5 | 8.5 |
| 680 HIPS | 1.8 | 0.8 | 4.5 |

Overall, crystal grade polystyrene (CX5229) preforms exhibited a higher shrinkage and warpage than HIPS (680) regardless of the preform design. A1 preforms exhibited a lower shrinkage and warpage than B preforms, while even lower shrinkage and warpage were achieved on A2 preforms. In particular, design A2 preform resulted in very low warpage, which is desirable for preform blow molding. In embodiments of the invention the preform has shrinkage of less than 38%, optionally less than 35%, optionally less than 30%. In embodiments of the invention the preform has a warpage of less than 8.5%, optionally less than 6%, optionally less than 4%.

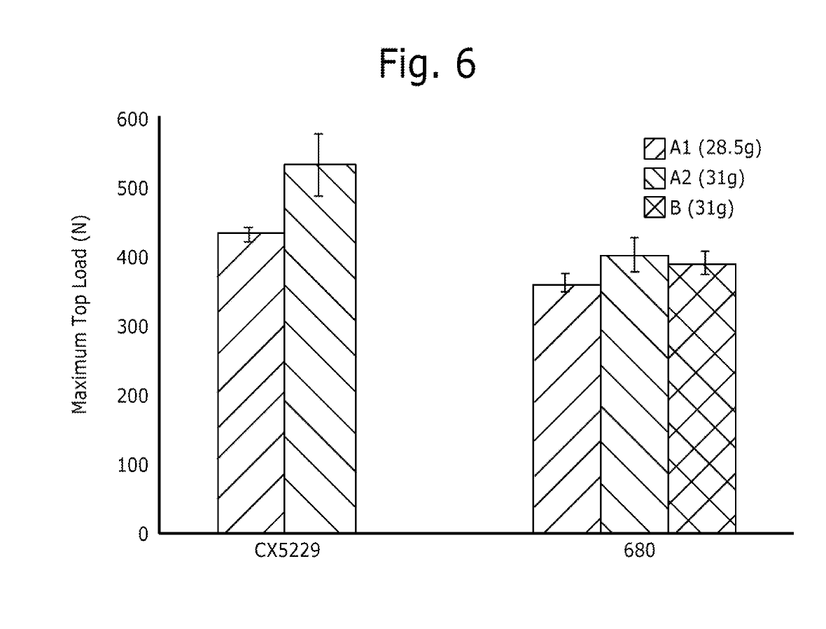

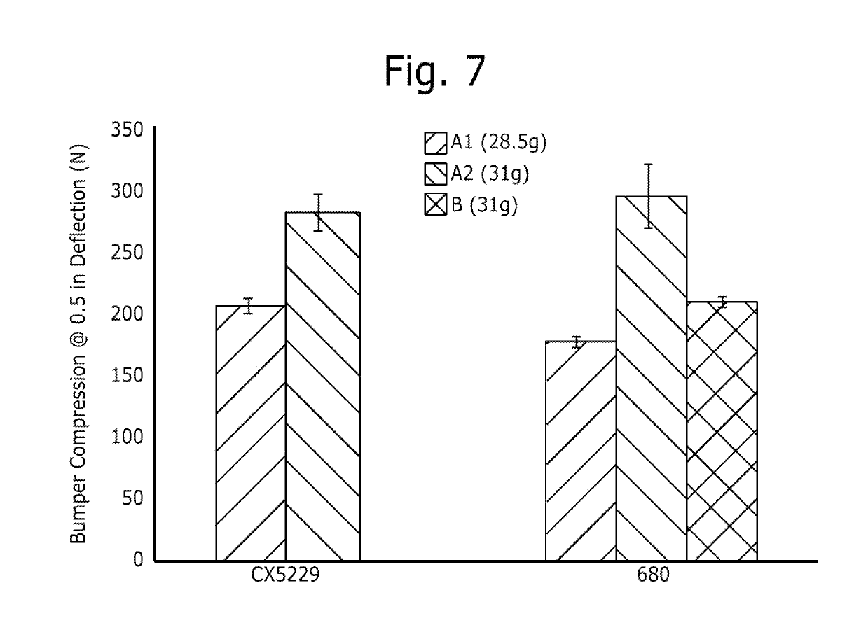

The bottles molded with A1 and A2 preforms also exhibit high top load strength. As shown in FIGS. 6 and 7, bottles made from A2 preform design exhibited higher top load and bumper compression strength than those of same weight but made from B preform design. There is no data for the B preform design with CX5229 as this preform failed to mold good bottles in which to test. top load and bumper compression strength are determined in accordance with ASTM 2659-95. Larger variations in bumper compression strength of the bottles were also observed, which indicated that bumper compression strength was more sensitive to the preform design than top load strength. That is because bumper compression is mainly sustained by the bottle bottom. A weak region on the bottle bottom, which is a typical result from an off-centered preform, will significantly lower the bumper compression strength of molded bottles. In embodiments, the molded bottles have bumper compression strength greater than 200 N. In alternate embodiments the bumper compression strength is greater than 225 N, and optionally greater than 250 N. In embodiments, the molded bottles have a top load strength greater than 325 N. In alternate embodiments, the top load strength is greater than 350 N, and optionally greater than 400 N.

The results have shown a preform design with relatively greater wall thickness helps reduce the shrinkage and warpage during reheating, and a bell-shaped design helps minimize the warpage. The A1 and A2 designs appear to be more suitable for polystyrene. After reheating, the preforms shrink less, have more uniform shrinkage and exhibit lower warpage.

The polymer of the present invention is a styrenic based polymer (e.g., polystyrene), wherein the styrenic polymer may be a homopolymer or may optionally comprise one or more comonomers. Styrene, also known as vinyl benzene, ethenylbenzene, phenethylene and phenylethene is an aromatic organic compound represented by the chemical formula C₈H₈. Styrene is widely commercially available and as used herein the term styrene includes a variety of substituted styrenes (e.g. alpha-methyl styrene), ring substituted styrenes such as p-methylstyrene, distributed styrenes such as p-t-butyl styrene as well as unsubstituted styrenes.

In an embodiment, the styrenic polymer has a melt flow as determined in accordance with ASTM D1238 of from 1.0 g/10 min to 30.0 g/10 min, alternatively from 1.5 g/10 min to 20.0 g/10 min, alternatively from 2.0 g/10 min to 15.0 g/10 min; a density as determined in accordance with ASTM D1505 of from 1.04 g/cc to 1.15 g/cc, alternatively from 1.05 g/cc to 1.110 g/cc, alternatively from 1.05 g/cc to 1.07 g/cc, a Vicat softening point as determined in accordance with ASTM D1525 of from 227° F. to 180° F., alternatively from 224° F. to 200° F., alternatively from 220° F. to 200° F.; and a tensile strength as determined in accordance with ASTM D638 of from 5800 psi to 7800 psi. Examples of styrenic polymers suitable for use in this disclosure include without limitation CX5229 and 680 HIPS, which are polystyrenes available from Total Petrochemicals USA, Inc. In an embodiment the styrenic polymer (e.g., CX5229) has generally the properties set forth in Table 3.

TABLE 3

| Physical Properties | Typical Value | Test Method |
|---|---|---|
| Melt Flow, | 3.0 | D1238 |
| 200° C./5.0 kg/10 min | | |
| Tensile Properties | | |
| Strength, psi | 7,300 | D638 |
| Modulus, psi (10⁵) | 4.3 | D638 |
| Flexural Properties | | |
| Strength, psi | 14,000 | D790 |
| Modulus, psi (10⁵) | 4.7 | D790 |
| Thermal Properties | | |
| Vicat Softening, deg. F. | 223 | D1525 |

In some embodiments, the styrenic polymer further comprises a comonomer which when polymerized with styrene forms a styrenic copolymer. Examples of such copolymers may include for example and without limitation α-methylstyrene; halogenated styrenes; alkylated styrenes; acrylonitrile; esters of methacrylic acid with alcohols having 1 to 8 carbons; N-vinyl compounds such as vinylcarbazole and maleic anhydride; compounds which contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art with the aid of this disclosure. For example, the comonomer may be present in the styrenic polymer in an amount ranging from 0.1 wt. % to 99.9 wt. % by total weight, alternatively from 1 wt. % to 90 wt. %, and further alternatively from 1 wt. % to 50 wt. %.

In an embodiment, the polymer also comprises a thermoplastic material. Herein a thermoplastic material refers to a plastic that melts to a liquid when heated and freezes to form a brittle and glassy state when cooled sufficiently. Examples of thermoplastic materials include without limitation acrylonitrile butadiene styrene, celluloid, cellulose acetate, ethylene vinyl acetate, ethylene vinyl alcohol, fluoroplastics, ionomers, polyacetal, polyacrylates, polyacrylonitrile, polyamide, polyamide-imide, polyaryletherketone, polybutadiene, polybutylene, polybutylene terephthalate, polychlorotrifluoroethylene, polyethylene terephthalate, polycyclohexylene dimethylene terephthalate, polycarbonate, polyetherimide, polyethersulfone, polyethylenechlorinate, polyimide, polylactic acid, polymethylpentene, polyphenylene oxide, polyphenylene sulfide, polyphthalamide, polypropylene, polysulfone, polyvinyl chloride, polyvinylidene chloride, and combinations thereof. For example, the thermoplastic material may be present in the styrenic polymer in an amount ranging from 0.1 wt. % to 50 wt. % by total weight.

In an embodiment, the polymer comprises an elastomeric phase that is embedded in a polymer matrix. For instance, the polymer may comprise a styrenic polymer having a conjugated diene monomer as the elastomer. Examples of suitable conjugated diene monomers include without limitation 1,3-butadiene, 2-methyl-1,3-butadiene, and 2-chloro-1,3-butadiene. Alternatively, the thermoplastic may comprise a styrenic polymer having an aliphatic conjugated diene monomer as the elastomer. Without limitation, examples of suitable aliphatic conjugated diene monomers include C₄ to C₉ dienes such as butadiene monomers. Blends or copolymers of the diene monomers may also be used. Examples of thermoplastic polymers include without limitation acrylonitrile butadiene styrene (ABS), high impact polystyrene (HIPS), methyl methacrylate butadiene (MBS), and the like. The elastomer may be present in an amount effective to impart one or more user-desired properties to the composition. Such effective amounts may be determined by one of ordinary skill in the art with the aid of this disclosure. For example, the elastomer may be present in the styrenic polymer in an amount ranging from 0.1 wt. % to 50 wt. % by total weight, or from 1 wt. % to 25 wt. %, or from 1 wt. % to 10 wt. %.

In accordance with the invention, the polystyrene based polymer also optionally comprises additives, as deemed necessary to impart desired physical properties. The additives used in the invention may be additives having different polarities. Additives suitable for use in the invention include without limitation zinc dimethacrylate, hereinafter referred to as “ZnDMA”, stearyl methacrylate, hereinafter referred to as “StMMA”, and hydroxyethylmethacrylate, hereinafter referred to as “HEMA”.

These additives may be included in amounts effective to impart desired physical properties. In an embodiment, the additive(s) are included in amounts of from 0.01 wt. % to 10 wt. %. In another embodiment, when ZnDMA is the additive, it is present in amounts of from 0.01 wt. % to 5 wt. %. In another embodiment, when the additive is StMMA or HEMA, the additive is present in amounts of from 1 wt. % to 10 wt. %.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

As used herein, the term “room temperature” means that a temperature difference of a few degrees does not matter to the process under investigation. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A preform for use in blow molding processes of polystyrene based polymer comprising:
a neck comprising an internal neck diameter and an external neck diameter and having a first neck end and a second neck end;
a body comprising an internal body diameter and an external body diameter which together form a sidewall;
the body having a first body end connected to the second neck end and a second body end that is closed, which together form a first body length;
the body having a first external body diameter at the first body end and a second external body diameter which is less than the first external body diameter;
the body having a transition zone defined by the length wherein the external body diameter decreases from the first external body diameter to the second external body diameter, the location where the external body diameter equals the second external body diameter defining a transition point;
wherein the transition zone is at least 50% of (d₁-d₂);
the body having a second body length from the transition point to the second body end;
wherein the second external body diameter is at most 95% of the first external body diameter;
wherein the second body length is at most 95% of the first body length.

2. The preform of claim 1, wherein the second external body diameter is at least 50% of the first external body diameter.

3. The preform of claim 1, wherein the second body length is at least 60% of the first body length.

4. The preform of claim 1, wherein the first external body diameter ranges from 25.0 mm to 40.0 mm.

5. The preform of claim 1, wherein the second external body diameter ranges from 12.5 mm to 38.0 mm.

6. The preform of claim 1, wherein the thickness of the sidewall is greater than 2.0 mm.

7. The preform of claim 1, wherein the thickness of the sidewall is greater than 2.0 mm for a 31 g preform used for blow molding a 500 mL bottle.

8. The preform of claim 1, wherein the preform material comprises polystyrene or a polymeric mixture comprising a majority of polystyrene.

9. The preform of claim 8, further comprising a gas-barrier coating material.

10. An article formed by the blow molding of the preform of claim 1.

11. A preform mold used for the molding of the preform of claim 1.

12. The preform of claim 1, wherein the preform has a shrinkage of less than 38% and a warpage of less than 8.5% when reheated during a blow molding process.

13. The preform of claim 1, wherein the preform has a shrinkage of less than 30% and warpage of less than 4.0% when reheated during a blow molding process.

14. A method of forming a blow molded article comprising:
providing a polystyrene based polymer;
forming a preform from the polystyrene based polymer, wherein the preform comprises:
a neck comprising an internal neck diameter and an external neck diameter and having a first neck end and a second neck end;
a body comprising an internal body diameter and an external body diameter which together form a sidewall;
the body having a first body end connected to the second neck end and a second body end that is closed, which together form a first body length;
the body having a first external body diameter at the first body end and a second external body diameter which is less than the first external body diameter;
the body having a transition zone defined by the length wherein the external body diameter decreases from the first external body diameter to the second external body diameter, the location where the external body diameter equals the second body external diameter defining a transition point;
wherein the transition zone is at least 50% of (d₁-d₂);
the body having a second body length from the transition point to the second body end;
wherein the second external body diameter is at most 95% of the first external body diameter;
wherein the second body length is at most 95% of the first body length;
heating the preform; and
injection blow molding the preform into an article.

15. The method of claim 14, further comprising injection stretch blow molding the preform into an article.

16. The method of claim 14, wherein the second external body diameter of the preform ranges from 50% to 95% of the first external body diameter of the preform.

17. The method of claim 14, wherein the second body length of the preform ranges from 60% to 95% of the first body length of the preform.

18. The method of claim 14, wherein the thickness of the preform sidewall is greater than 2.00 mm for a 31 g preform used for blow molding a 500 mL bottle.

19. The method of claim 14, wherein the heating of the preform results in a shrinkage of less than 38% and a warpage of less than 8.5%.

20. An article formed by method of claim 14.
